(19) United States
(12) Patent Application Publication
(10) Pub. No.: US 2008/0285126 A1
(43) Pub. Date: Nov. 20, 2008

(54) Screen Surround

(75) Inventors: Scott Bartle, Innaloo (AU); Kenneth Elwyn Bartle, Innaloo (AU)

Correspondence Address: JAMES D. STEVENS;REISING, ETHINGTON, BARNES, KISSELLE, P.C., P.O. BOX 4390, TROY, MI, 48099, US

(73) Assignee: HOMESCREENS.COM.AU PTY LIMITED, Innaloo (AU)

(21) Appl. No.: 11/911,485

(22) PCT Filed: Apr. 13, 2006
(86) PCT No.: PCT/AU2006/000502

§ 371 Date: Jun. 6, 2008

(30) Foreign Application Priority Data
Apr. 13, 2005 (AU) 2005901832

(51) Int. Cl. G03B 21/56; B65H 23/00

(52) U.S. Cl. 359/450; 226/2

(57) ABSTRACT

A screen frame (82) for a fabric screen (90) is comprised of four screen surround portions (10, 11). Each screen surround portion has a screen receiving portion (20) opening to the front of the screen, and a resilient screen retaining means (60) to hold an edge of the screen within the screen receiving portion. Each screen surround portion also has provision for the insertion of stiffening material (34) in at least one direction.

### FIELD OF THE INVENTION

The present invention relates to a screen surround or frame such as one supporting a home-cinema screen.

### BACKGROUND TO THE INVENTION

A known type of screen for home cinema systems comprises a rigid rectangular frame which supports a tensioned fabric screen, onto which pictures may be projected. The rigidity of the frame must be sufficient to prevent distortion, and to ensure that the fabric is flat.

The frame must also provide a surround to the screen which is non-reflective, and does not distract a viewer's attention from the images projected onto the screen.

Known screen surrounds and frames are typically formed from extruded metal sections. The design of the extrusion is such that the extruded section is sufficiently rigid to prevent bending even when a long length of the section is used to support a tensioned screen. Typically, the screen frame extrusion is designed so that no bending will occur in the case of a free standing screen made to a maximum size.

It will be appreciated that such extrusions have a rigidity in excess of that required when used for screens smaller than the maximum size, or for screens which may be mounted to a wall or other structure. This results in an inefficient use of materials, and possibly a screen surround which is too large to be aesthetically pleasing.

Known screen surrounds have means for fixing the fabric to the screen concealed behind the screen. In use, this means that a screen must be assembled before it can be affixed to a wall. Consequently, the screen cannot rely on the wall to provide rigidity. Known screen surrounds and frames have various methods of attaching the tensioned fabric thereto. These methods typically allow for fabrics of a certain thickness and stretch properties to be used within a given frame. Known frames have little provision for being used with a variety of different fabrics having different properties.

The present invention attempts to overcome at least in part some of the aforementioned disadvantages of previous screen surrounds and frames

### SUMMARY OF THE INVENTION

In accordance with one aspect of the present invention there is provided a screen surround portion comprising an elongate framing member, the elongate framing member having a screen receiving portion in which an outer edge of a screen may be received, the screen receiving portion having an associated screen retaining means, characterised in that the elongate framing member has a reinforcement means receiving portion in which a reinforcement means may be received in order to alter the stiffness of the screen surround portion.

Advantageously, this allows for the rigidity of the screen surround portion to be altered to accommodate different screen sizes and screen tensions.

Preferably, the reinforcement means receiving portion comprises a first elongate receiving portion oriented in a direction substantially parallel to the screen, and a second elongate receiving portion oriented in a direction substantially perpendicular to the screen.

Also preferably, the screen receiving portion is oriented towards a front side of the screen surround portion.

### BRIEF DESCRIPTION OF THE DRAWINGS

The present invention will now be described, by way of example, with reference to the accompanying drawings, in which:

FIG. 1 is a cross sectional view of a screen surround portion in accordance with a first embodiment of the present invention;

FIG. 2 is a cross sectional view of a screen surround portion in accordance with a second embodiment of the present invention;

FIG. 3 is a cross sectional view of a screen surround covering portion for use with the present invention;

FIG. 4 is a cross sectional view of a screen retaining means for use with the present invention;

FIG. 5 is a plan view of a screen surround in accordance with the present invention;

FIG. 6 is a cross sectional view of a screen fabric being introduced into the screen surround portion of FIG. 1;

FIG. 7 is a cross sectional view of the screen fabric of FIG. 6 during installation;

FIG. 8 is a cross sectional view of the screen fabric of FIG. 6 following installation;

FIG. 9 is a cross sectional view of the screen retaining means shown in FIG. 4 during one mode of screen fabric installation; and

FIG. 10 is a cross sectional view of the screen surround portion of FIG. 1 in use, shown following assembly.

### DESCRIPTION OF PREFERRED EMBODIMENTS

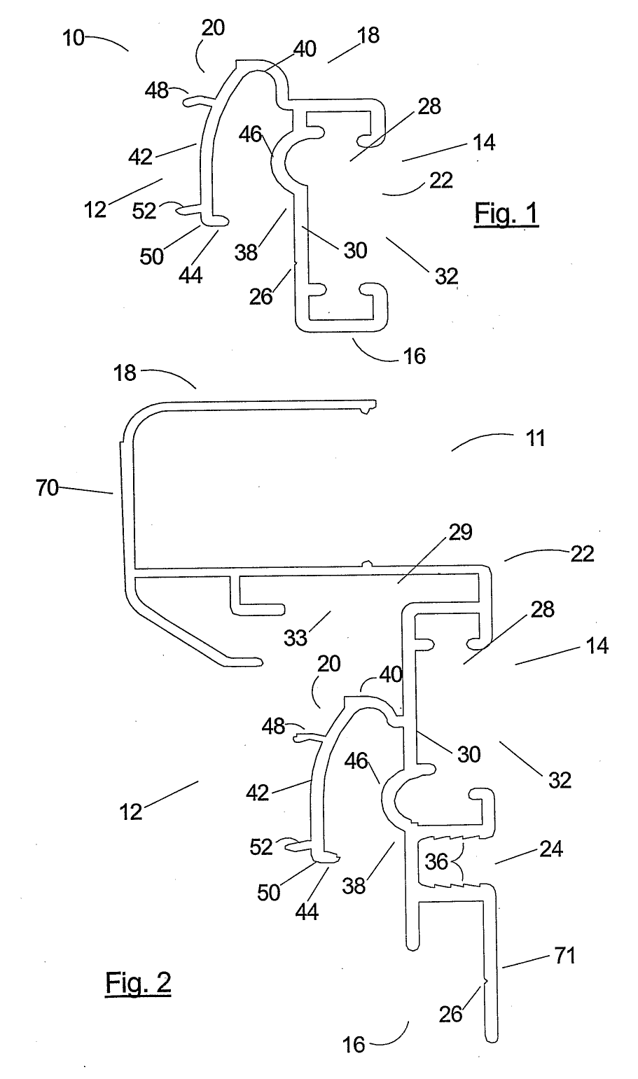

Referring to the Figures, there is shown in FIG. 1 a cross sectional view of a screen surround portion comprising a framing member 10. The framing member 10 is formed from a metal extrusion, and is thus elongate and of indeterminate length.

The framing member 10 has a front side 12 and a rear side 14, and an inner edge 16 and an outer edge 18.

The framing member 10 includes a screen receiving portion 20, and a reinforcement means receiving portion 22.

The reinforcement means receiving portion 22 comprises a substantially C-shaped channel 28 located adjacent the inner edge 16 of the framing member 10. The channel 28 has an opening 32 at the rear side 14 of the framing member 10, and an oppositely disposed back wall 30 which separates the screen receiving portion 20 and the reinforcement means receiving portion 22.

The channel 28 is substantially rectangular, and forms a receiving portion arranged to receive therein a flat, elongate reinforcing means 34. The reinforcing means 34 is formed from suitable stiff material so as to provide a required degree of stiffness to the framing member 10. The channel 28 and hence the reinforcing means 34 is substantially parallel to the rear side 14 of the framing member 10.

The screen receiving portion 20 is located at the front side 12 of the framing member 10, adjacent the outer edge 18. The screen receiving portion 20 comprises a substantially V-shaped channel with an opening oriented towards the inner edge 16 of the framing member 10. The V-shaped channel has a rear surface 38, an apex 40, a front portion 42 and a retaining edge 44.

The rear surface 38 is predominantly flat, and is contiguous with the back wall 30 of the channel 28. The rear surface 38 includes a hump 46 located in a position opposed to the mid-point of the front portion 42. The hump 46 extends along the (indeterminate) length of the rear surface 38.

The front portion 42 is curved, and is concave relative to the rear surface 38. The front portion 42 extends from the apex 40 to a frontmost, innermost location 50 approximately level with the centre of the back wall 30 of the channel 28.

The retaining edge 44 extends rearwardly from the location 50 approximately one quarter of the distance between the location 50 and the rear surface 38.

The front portion 42 has a first external protrusion 48 extending forwardly of the front portion 42 near the apex 40, and a second external protrusion 52 extending forwardly of the front portion 42 near the location 50.

The screen receiving portion 20 has an associated screen retaining means 60 as shown in FIG. 4. The screen retaining means 60 is elongate, and is substantially U-shaped in cross section, with a front leg 62, a rear leg 64 and a base portion 66. The screen retaining means 60 is comprised of a resilient deformable material such as PVC plastic.

The front leg 62 is of slightly smaller width than the front portion 42 of the screen receiving portion 20. The rear leg 64 has a width sufficient to engage with the hump 46 of the screen receiving portion 20.

FIG. 2 shows a cross sectional view of a second embodiment of the invention, with like numerals referring to like features. As with the embodiment of FIG. 1, the screen surround portion comprises a framing member 11. The framing member 11 is formed from a metal extrusion, and is thus elongate and of indeterminate length.

The framing member 11 of the second embodiment has a reinforcement means receiving portion 22 comprising a first elongate receiving portion formed by a first channel 28 and a second elongate receiving portion formed by a second channel 29.

The first channel 28 is similar to the channel 28 of the first embodiment. The second channel 29 is adjacent the first channel 28, and perpendicular to the first channel 28. The second channel 29 thus extends between the front side 12 and the rear side 14 of the framing member 11. The second channel 29 has an opening 33 adjacent the apex 40 of the screen receiving portion 20. The first and second channels 28, 29 are similar in size.

The framing member 11 also includes a spline receiving portion 24, located at an inner edge of the first channel 28. The spline receiving portion 24 comprises a rearwardly facing narrow channel having serrated inner walls 36, which are arranged to retain a spline within the channel.

The frame member 11 of the second embodiment further includes an outer surround portion 70 and a mounting portion 71. The outer surround portion 70 extends outwardly and forwardly from the frame member 11. The mounting portion 71 extends inwardly along the rear edge 14 from the spline receiving portion 24.

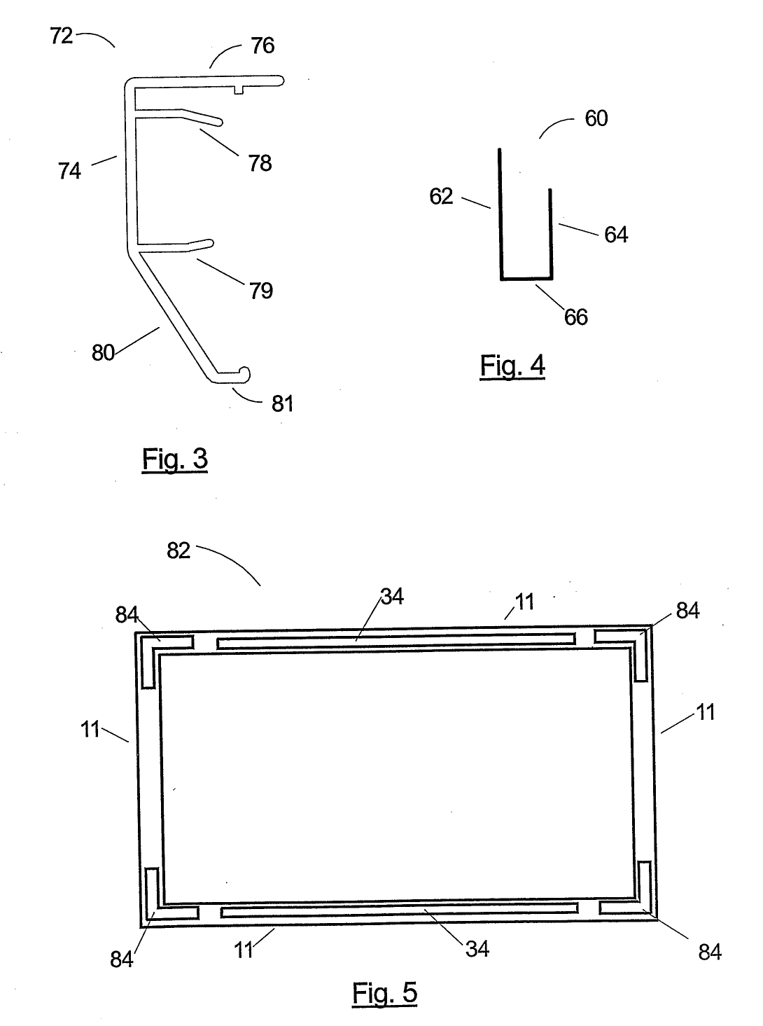

FIG. 3 shows a cross section of a screen surround covering portion 72 for use with the frame members 10, 11 described herein above. The screen surround covering portion 72 is elongate, and of indefinite length. The screen surround covering portion 72 comprises a front wall 74, an outer wall 76, a first inner wall 78, a second inner wall 79 and an inner covering portion 80.

The outer wall 76 extends rearwardly from an outermost edge of the front wall 74, and is substantially perpendicular to the front wall 74. The first and second inner walls 78, 79 are substantially parallel to the outer wall 76, and extend from the front wall 74 rearwardly of the screen surround covering portion 72. Each of inner walls 78, 79 have slightly curved ends arranged to engage, in use, with the first and second external protrusions 48, 52 of the screen receiving portion 20.

The inner walls 78, 79 are spaced and dimensioned so as to “snap” over the first and second external protrusions 48, 52 and to be held in a friction fit.

The inner covering portion 80 extends inwardly and rearwardly of the front wall 74 from an inner edge thereof. It ends with a inner lip portion 81 which, in use, locates adjacent a screen fabric.

In use, a screen frame 82 as shown in FIG. 5 is constructed by joining four frame members 10 or frame members 11 in a rectangular configuration. Each of the frame members 10, 11 being so joined has a mitred end, and can be joined to an adjacent frame member 10, 11 by the use of a corner piece 84 which slots into the end of the channel 28.

The rigidity of the screen frame 82 can then be increased to a minimum desired rigidity by the insertion of reinforcing means 34 into the channels 28 and/or 29. The lengths and properties of the reinforcing means 34 thus used can be chosen to provide the necessary stiffness of the screen frame. In the example of FIG. 5, it will be seen that reinforcement was required only in a horizontal direction. When the screen frame 82 is fixed to a rigid surface such as a wall, no reinforcing means 34 may be required.

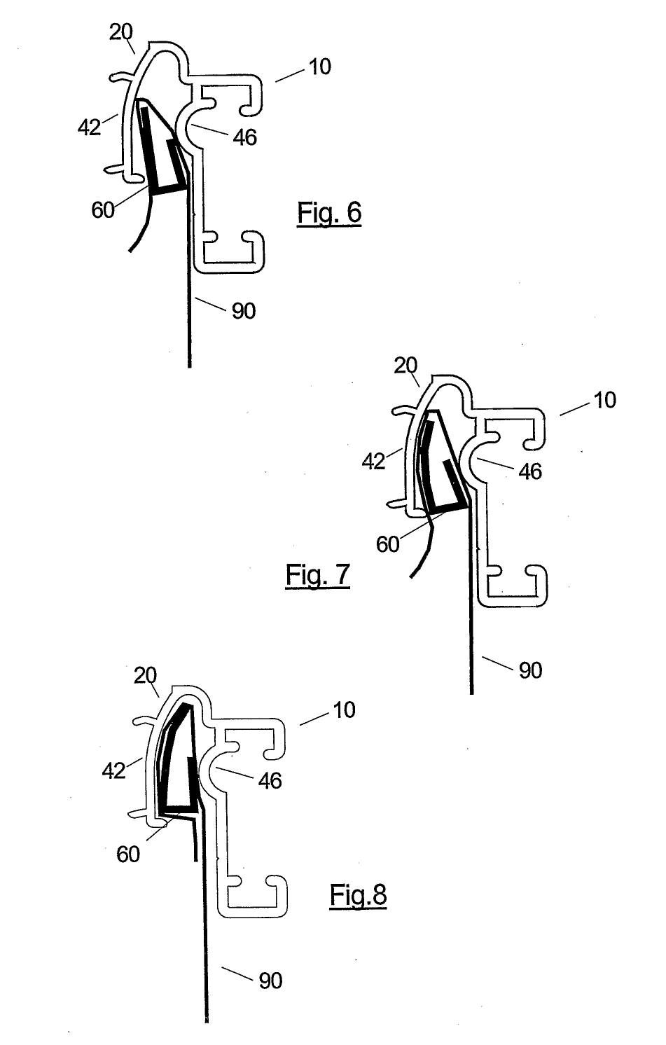

Insertion of a screen fabric 90 into the screen frame 82 is shown in FIGS. 6 to 8. The screen fabric 90 is wrapped about the open end of the screen retaining means 60. The screen retaining means 60 is then urged into the screen receiving portion 20 until the rear leg 64 is forced up against the hump 46. Further application of a pushing force through the base portion 66 causes the screen retaining means 60 to deform, and permits the front leg 62 to conform to the shape of the front portion 42 of the screen receiving portion 20. In this position the base portion 66 is held against the retaining edge 44, and the screen retaining means is thus maintained in position.

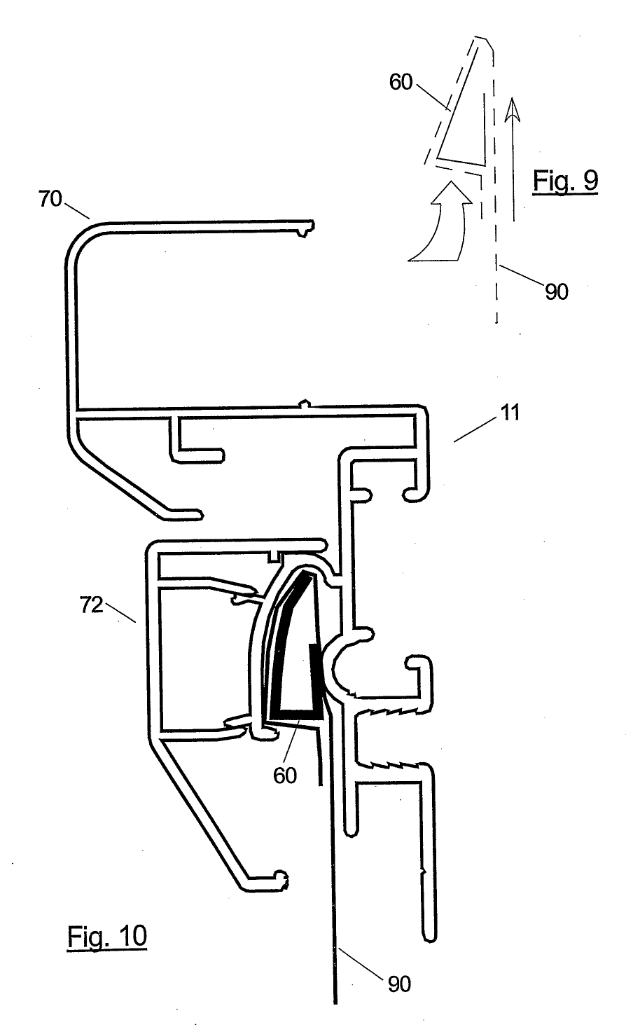

In order to provide additional tension of the screen fabric 90, the fabric 90 can be wrapped over the base portion 66 during tensioning, as shown in FIG. 9.

It will be appreciated that, as the opening to the screen receiving portion 20 is located at the front side of the frame member 10, 11, the screen 90 can be inserted even when the frame member 10, 11 is fixed to a wall. To assist in centering wall screws during this procedure, the frame member 10, 11 is extruded with a V-groove 26. In the second embodiment of the frame member the V-groove 26 is in the mounting portion 71. In the first embodiment of the frame member the V-groove 26 is in the back wall 30. Where the screen 82 is to be screwed to a wall it is considered unlikely that reinforcing means will be required.

Following insertion and tensioning of the screen fabric 90, the screen surround covering portion 72 is “snapped” on to the frame member 10, 11 over the first and second external protrusions 48, 52. The screen surround covering portion thus hides the arrangement from view. This is shown in FIG. 10.

In some arrangements it is considered desirable to have a backing fabric located behind the screen fabric 90. The present invention allow for this via use of the spline receiving portion 24. A spline can be used to hold a backing fabric in position, if desired.

It will be appreciated that the present invention allows for the creation of a screen of any desired size from small through to large. Through judicious choice of which framing member 10, 11 to use, and how much reinforcement 34 is required for a particular application, self supporting screens can be made efficiently. Further, with the ability for the screen fabric 90 to be fitted from in front, effective use can be made of rigidity supplied by a wall onto which the screen is mounted.

Modifications and variations as would be apparent to a skilled addressee are deemed to be within the scope of the present invention.

1. A screen surround portion comprising an elongate framing member, the elongate framing member having a screen receiving portion in which an outer edge of a screen may be received, the screen receiving portion having an associated screen retaining means, wherein the screen receiving portion is accessible from a front side of the screen surround portion, the elongate framing member also having a reinforcement means receiving portion arranged to receive a reinforcement member to facilitate increased tensile properties of the framing member where necessary or desired.

2. A screen surround portion as claimed in claim 1, wherein the screen receiving portion is substantially V-shaped.

3. A screen surround portion as claimed in claim 2, wherein the screen receiving portion opens towards an inner edge of the screen surround portion.

4. A screen surround portion as claimed in claim 3, wherein the screen receiving portion has an elongate protrusion along one surface, the protrusion being opposed by a retaining edge disposed along an open end of the screen receiving portion.

5. A screen surround portion as claimed in claim 1, wherein the screen retaining means is resiliently deformable and is arranged to be angularly displaced within and along the length of the screen receiving portion.

6. A screen surround portion as claimed in claim 5, wherein interdependent juxtapositioning of the screen retaining means, the protrusion and the retaining edge, act in concert on the screen retaining means to hold the screen captive in use.

7. A screen surround portion as claimed in claim 6, wherein the screen retaining means is unattached to the screen, which in use, facilitates independent screen tension adjustments anywhere along the length of the screen retaining means.

8. A screen surround portion as claimed in claim 1, wherein the elongate framing member is arranged to engage with a cover portion, the framing member and the cover portion being interengageable by means of a friction fit.

9. A screen surround portion as claimed in claim 1, wherein the elongate framing member has one or more of the reinforcement means receiving portions in one or more planes in which one or more reinforcement members may be received.

10. A screen surround portion as claimed in claim 1, wherein the elongate framing member has one or more reinforcement means receiving portions in which one or more reinforcement members may be received, the or each reinforcement member being held captive within all or a substantial part of the elongate framing member and arranged parallel along the screen surround portion so as to amalgamate the tensile properties of the reinforcing means and the screen surround portion.

11. A screen surround portion as claimed in claim 10, wherein concealed and direct fixing of the screen surround portion to an underlying substrate obviates the need for the reinforcement member or members.

12. A screen frame formed from a plurality of screen surround portions as claimed in claim 1.
